(19) United States
(12) Patent Application Publication
(10) Pub. No.: US 2026/0176519 A1
(43) Pub. Date: Jun. 25, 2026

(54) IMMERSION COOLING FLUID CONTAINING WHITE ALKANES

(71) Applicant: HOLLYFRONTIER LSP BRAND STRATEGIES LLC, Dallas, TX (US)

(72) Inventors: Matthew Joyce, Dallas, TX (US); MARYAM MOHAGHEGHI, Mississauga (CA); STEPHEN KRAWIEC, Mississauga (CA); VITTORIA LOPOPOLO, Mississauga (CA)

(21) Appl. No.: 19/425,254

(22) Filed: Dec. 18, 2025

Related U.S. Application Data
(60) Provisional application No. 63/736,014, filed on Dec. 19, 2024.

(51) Int. Cl. C09K 5/10

(52) U.S. Cl. CPC C09K 5/10

(57) ABSTRACT

The present invention describes an immersion cooling fluid that incorporates White Alkanes (WA) with Highly Refined Alkanes (HRA) producing a unique mixture (“WA-HRA Immersion Cooling Fluid”). The immersion cooling fluid/white alkane mixture, or WA-HRA Immersion Cooling Fluid, provides high thermal performance, material compatibility and extended operating life. Existing fluids make a greater compromise between performance and sustainability. Unlike conventional thermal fluids that rely on non-renewable resources, the WA-HRA Immersion Cooling Fluid utilizes integration of renewable oils derived from sustainable sources. This novel approach significantly reduces environmental impact and ensures long-term resource availability. It also provides an immersion cooling fluid with superior thermal properties, maximizing thermal conductivity, heat transfer efficiency, and stability across a wide range of temperatures.

This application is based upon and claims priority from U.S. Provisional application Ser. No. 63/736,014, which is incorporated herein by reference.

### BACKGROUND OF THE INVENTION

### Field of the Invention

Applicants'invention relates to combinations of base oils (Highly Refined Alkanes), White Alkanes derived from renewable sources and other additives for use in a unique immersion cooling fluid. The formulations have unique properties that are beneficial for immersion cooling applications as dielectric fluid for heat removal and cooling purposes. The unique mixture provides the ability to incorporate renewable content in immersion cooling applications and continue to provide high thermal performance, material compatibility and extended operating life, where conventional fluids will compromise either performance or sustainability.

### Background Information

Data is essential to businesses in both the private and public sectors as well as government. Businesses are inundated with vast amounts of data, which can be routinely collected from a variety of remote locations, inhospitable operating environments, and varying sources from all over the world. Due to the sheer magnitude of data, the way businesses handle computing has, and is, changing. The traditional computing model built on a centralized data center and internet is not optimum for moving endlessly growing volumes of real-world data. As a result, current data centers have transitioned from traditional on-premises physical servers to combinations of physical servers and virtual networks that support applications and workloads across multiple sets of physical infrastructure and incorporate a multi-cloud environment. Data centers typically include such components as: servers, firewalls, routers, switches, storage systems, and controllers. Data centers communicate with multiple other centers-both on-premises and in public and private clouds.

The amount of data being stored is astronomical, yet the expectation is for virtually instant access. Networks of computing and storage resources that provide for shared applications and data make up common data centers. Such application demands drive increased deployments of high-performance computers as well as accelerated implementation of cloud and edge computing infrastructures. Data centers are constantly evaluated and updated in order to provide faster data transfer, with increased efficiency, cost effectiveness, and sustainability.

A problem though, is that even the best-engineered power supplies will create heat because electricity is not 100% efficient. Electronic components all have some resistance to the currents running through them resulting in the release of excess energy as heat. This heat can have adverse effects on electronics. If the temperature is high enough, it can cause components to melt or break. Even if physical parts remain intact, high heat affects currents negatively. Components affected by heat can show poor performance, shortened lifespan, or damage/destruction. Conversely, electrical components tend to perform better within a given temperature range. Components that are forced to perform outside of that range have performance characteristics that start to suffer. A good cooling mechanism improves performance by keeping components within their optimal temperature range.

Heat is an inevitable byproduct of computer hardware operation. Thus, users must deal with heat generated within the system. Excess heat can cause a system slowdown. Too high of a temperature may reduce performance or even damage the equipment. Individual physical components that are commonly cooled include the CPU, graphics processing unit, and the northbridge.

It has been estimated that data centers, physical facilities that organizations use to house their critical applications and data, consume approximately 1% of global electricity-and that more than a third of this power is used for cooling electrical components.

There are multiple means that have conventionally been used to cool electronic and computing components. One has been to mount heat sinks on the heat-producing components (e.g. central processing unit, graphics processing unit, memory module). The heat sinks may be connected to small tubing that carries liquid to and from the component, maintaining optimal temperatures. Coolant pumps may be integrated into the heat sink, eliminating the need for external pumping units. Another has been to use natural convection, forced convection, air conditioning or fans.

A more modern solution to both heating and energy consumption is immersion cooling. Immersion cooling uses liquid instead of air to remove heat from electronic hardware. Hardware components are immersed in a dielectric fluid which generally conducts heat but does not generally conduct electricity-acting as an insulator.

Immersion cooling methods provide for heat generating or sensitive components to be submerged in a dielectric fluid that draws away heat much more efficiently than air. Convection type heat transfer helps provide optimal server performance and reduces energy usage associated with air-cooling, or conduction type heat transfer.

Servers may be immersed in a dielectric, electrically non-conductive fluid that has significantly higher thermal conductivity than air. Dielectric fluids are poor electrical conductors but act as supporters for electrostatic fields. Traditionally, dielectric fluid has been used to provide electric insulation by preventing and quenching electric discharges. Often, it has been used as an insulator in high electric voltage applications and helps suppress arcing and corona. Thermal conductivity is a measure of a material's inherent ability to transfer or conduct heat. Thermal conductivity is generally denoted using k, λ, or κ. It is also defined as the material plate of unit thickness conducting the amount of heat per unit time per unit area, with its faces differing by one unit of temperature. Thus, it might be said that heat travels more easily through a material with a relatively higher thermal conductivity as compared to a material with a relatively lower thermal conductivity. Materials with a relatively higher number of free electrons generally have relatively higher thermal conductivity because heat conductivity occurs through molecular agitation and contact and does not result in the bulk movement of the solid itself.

There are a few possibilities for immersion cooling, one being direct liquid immersion cooling in which there are no physical barriers separating the microelectronic chips and the surface of the substrate from the liquid coolant. This form of cooling allows heat to be removed directly from the components to the fluid with no intervening thermal conduction resistance. It is anticipated that the components will need to undergo some physical modifications in order to allow for submersion in the fluid, but because the fluid is expected to be dielectric, the components should be similar to ones placed in cabinets and used in air-cooled data centers.

A single-phase immersion cooling fluid is a dielectric fluid for cooling electronic components, in which the fluid remains in a liquid state throughout the entire cooling process. Heat is transferred from the components to the fluid, which is then circulated to a heat exchanger to dissipate the heat before returning to the tank. Conversely, in a two-phase system the liquid is a dielectric fluid with a low boiling point that, when electronic components are submerged therein, boils to remove heat. Vapor rises, condenses on a heat exchanger at the top of the tank, and drips back into the bath to repeat the passive cooling cycle.

A direct, single-phase immersion cooling fluid is a dielectric fluid that remains in its liquid state to directly absorb heat from submerged electronic components in a process that does not involve boiling or phase change.

Immersion technologies may be manufactured using different design solutions, including the type of fluid and physical configuration. One approach is that individual servers are housed in separate liquid-filled vessels. Another is that multiple servers may be immersed in a container filled with a cooling liquid. In either of these solutions, the cooling liquid draws heat from the heat producing electrical component, and then the heat may be dissipated from the liquid, or the liquid may be re-cooled using a heat exchanger at or near the facility.

There can be many advantages due to immersion cooling versus traditional cooling. For example, immersion cooling can reduce capital costs and energy use. Computational efficiency generally increases as well, resulting in greater computational power for the same electricity use. Other benefits that may result from immersion cooling can include: decreasing needed space (which can reduce buildout costs); providing higher server density; increasing hardware life and performance; reducing maintenance; physical protection by the fluid of the equipment; no need to throttle back CPUs or GPUs to avoid overheating; protects electronics from airborne contaminants; no chillers or direct expansion (DX) cooling equipment (in which a refrigerant coil is placed directly in the supply liquid stream) to maintain; no need for fans, air handlers, air conditioning or humidity control; can reduce power to cool by 98% versus air cooling; can lower power usage effectiveness (“PUE”) to near 1.0 (a PUE of 1.0 means that all energy is being used for computing, or conversely, that no energy is being used on cooling); uses less water (data centers can use an inordinate amount of water); can reduce the carbon footprint; reduced power plant emissions; and tends to be quieter than traditional cooling means because fan noise and vibration is eliminated.

The American Petroleum Institute (“API”) has categorized base stocks into five (5) categories, or groups—Groups I-V (API 1509, Appendix E). Base stocks are often used as lubricants, which frequently have various additives mixed with the base stock. If a base stock is classified as Group I-III, that base stock will be composed of crude petroleum oil that has been treated. As a general statement, oil-based lubricants are typically composed of 80-99% base oil. In contrast, Groups IV and V are not derived directly from crude oil.

Certain physical properties are used to describe the characteristics of the base oils. “Viscosity” is a measure of the substance's resistance to deformation at a given flow rate. Viscosity is usually measured in centistokes (“cSt”) or in other units such as Saybolt Universal Seconds (SUS). Viscosity can be used to define base oil grade and is determined by various methods, such as gravity flow capillary viscometer. The “viscosity-index” (“VI”) relates to how much the viscosity changes with temperature-how much it thins out at higher temperatures and thickens at lower temperatures, and is determined by the variance in viscosity between 40° C. and 100° C. “Specific gravity” defines the density of oil relative to water and is measured by a hydrometer. The base oils'“flash point” describes its high-temperature, flammability property, and is the temperature at which a flash surface flame occurs. “Pour point” defines the lowest temperature at which an oil is observed to flow by gravity in a specified lab test. Specifically, the pour point is 3 degrees C (5 degrees F) above the temperature at which the oil shows no movement when a lab sample container is held horizontally for 5 seconds. Related to the pour point is the “pour point D97 value” which refers to the lowest temperature at which an oil or petroleum product flows under gravity, as determined by the ASTM D97 standard test method. This value indicates an oil's cold-flow properties, showing the point where it solidifies and stops moving, with lower negative numbers meaning better performance in cold conditions.

Group I base oils are refined from petroleum crude oil but are the least refined base oil. Group I base oils are solvent-refined, which is a simpler refining process, and Group I base oils typically range from amber to golden brown in color due to the sulfur, nitrogen and aromatic ring structures remaining in the oil. Two main characteristics of Group I base oils are that they are composed of one or both of: less than 90% saturates and/or greater than 0.03% sulfur. Group I base oils have a VI range of 80 to 119.

Group II base oils are defined as being, both, more than 90% saturates and less than 0.03% sulfur. They are typically created by using a hydrotreating process to replace the traditional solvent-refining process, which is a more complex process than what is used for Group I base oils. Hydrogen gas is used to remove undesirable components from the crude oil. This results in a clearer than Group I, and primarily colorless base oil with very few sulfur, nitrogen, or aromatic ring structures. The majority of the hydrocarbon molecules of Group II base oils are saturated, giving them better antioxidation properties. The VI of Group II base oils ranges from 80 to 119 but is typically above 100.

Group III base oils are greater than 90 percent saturates and less than 0.03 percent sulfur. These oils are typically refined using a hydrogen gas process to clean up the crude oil even more than Group II base oils and generally are severely hydrocracked (higher pressure and heat). This longer process is designed to achieve a purer base oil. The resulting base oil is clear and colorless. Group III base oils are more resistant to oxidation than Group I and Group II oils. The VI of Group III base oils is 120 or greater. Group III base oils are widely considered as mineral oils as they are derived directly from the refining of crude oil. However, they are considered synthetic base oils by other people for marketing purposes due to the belief that the harsher hydrogen process has created new chemical oil structures that were not present before the process.

Group IV base stocks are full synthetic polyalphaolefins. Polyalphaolefins (“PAO”) are made through a process called synthesizing using pure chemicals created in a chemical plant as opposed to being created by distillation and refining of crude oil. They have a much broader temperature range and are great for use in extreme cold conditions and high heat applications.

Group V base stocks are classified as all other base stocks that are not classified as belonging in Groups I-IV. These base stocks are at times mixed with other base stocks to enhance the fluid's properties. Common Group V base stocks include naphthenic base oils, various synthetic esters, polyalkylene glycols (PAGs), phosphate esters, silicone, polyol ester, biolubes, and various other chemistries.

The terms “base stocks” and “base oils” are often used interchangeably, but there are differences. A base stock is a single product, usually defined by its viscosity grade. A mixture of one or more base stocks in a finished lubricant is a base oil. A base oil is always defined in the context of the formulated lubricant. Base oil properties can vary depending on their API group.

Mineral oil can be obtained as a distillation product made from highly refined, purified, distilled, and processed petroleum. API Group I, II, III, III+ can all be described as mineral oils.

White mineral oil is colorless, odorless, tasteless, and is used especially in medicine and in pharmaceutical and cosmetic preparations. White mineral oils are highly refined petroleum mineral oil that are inert and stable compounds. White mineral oils mostly consist of saturated hydrocarbons. Different methods of purifying are applied: hydrogenation, hydro-isomerization, or sulfur trioxide (SO₃), sulfuric acid, or oleum treatment of petroleum products, or a combination of the above. White mineral oils are used in many applications in personal care, pharma, food industry (including lubricants), and many other applications where non-toxic oil with low biological activity and high stability is required. White mineral oil is often used as an ingredient in baby lotions, cold creams, ointments, lubricants, cosmetics, moisturizers, laxatives, and many other cosmetic and personal care products. White mineral oil is also used in the manufacture of some basic foods. It is used as a binding agent, but can also be applied to grains like wheat, rice, oats and barley to help keep dust from adhering to the product. White mineral oil is also an ingredient in some types of gummy candies to keep them from sticking together.

White mineral oil consists of a complex combination of hydrocarbons obtained from the intensive treatment of a petroleum fraction with sulfuric acid and oleum, or by hydrogenation, or by a combination of hydrogenation and acid treatment. Additional washing and treating steps may be included in the processing operation. It consists of saturated hydrocarbons having carbon numbers predominantly in the range of C15 through C50. The term “white mineral oil” is a misnomer, in that white mineral oils are clear, and tend to be water white (ASTM D156 Saybolt color +30), and meet guidelines established by the Food and Drug Administration (FDA) in the Code of Federal Regulations (CFR). 21 CFR 172.878 and 21 CFR 178.3620(a) and (b). They meet the purity requirements of the European Pharmacopoeia (Ph. Eur.), United States Pharmacopoeia (USP), National Formulary (NF), and Japanese Pharmacopoeia (JP). Moreover, they are in compliance with the purity requirements of former monographs of the British Pharmacopoeia (BP), Deutsche Arzneibuch (DAB) or French Codex. Typical properties of white mineral oils include: density from 810-890 kg/m³ at 20° C. (using the standard test for density ASTM D-1298), viscosity from 3-240 cSt at 40° C. (using the standard test for viscosity ASTM D-445), pour point from −18-+3° C. (using the standard test for pour point ASTM D-97), flash point from 115-290° C. (using the standard test for flash point ASTM D-92). Other standards and tests exist for these properties as well.

Direct liquid immersion cooling offers a high heat transfer coefficient which reduces the temperature rise of the chip surface above the liquid coolant temperature. The relative magnitude of a heat transfer coefficient is affected by both the coolant and the mode of convective heat transfer (i.e. natural convection, forced convection, or boiling). Water can be an effective coolant and boiling offers a high heat transfer coefficient. Direct liquid immersion cooling also offers greater uniformity of chip temperatures compared to what is provided by air cooling.

A major consideration in using immersion cooling is choosing the cooling fluid. The selection of a liquid for direct immersion cooling cannot be solely based on heat transfer characteristics. Chemical compatibility of the coolant with the chips and other packaging materials exposed to the liquid are important considerations.

Fluids used in immersion cooling should have several key characteristics that make them suitable, or more appropriate and effective, for this use. The fluid's characteristics may include: thermal conductivity, specific heat capacity, density, electrical resistance (or insulation), chemical stability, low viscosity, non-toxic and environmentally friendly, high boiling point, reasonable pour point, compatibility with the electronic components being cooled, and cost effectiveness. Thermal conductivity allows the fluid to efficiently absorb and transfer heat away from electronic components, ensuring that they remain within safe operating temperatures. Effective thermal management is essential to maintain the performance and longevity of the hardware. The fluid must be electrically insulating to prevent short circuits and other electrical issues. This characteristic ensures that the electronic components can operate safely while submerged in the fluid. Immersion cooling fluids need to be chemically stable to prevent degradation over time. Stability ensures that the fluid maintains its thermal and electrical properties throughout its lifespan, reducing the need for frequent replacements and minimizing maintenance costs. The fluid should also be non-reactive with the materials used in electronic components to avoid corrosion or other chemical damage and be able to solubilize the possible presence of impurities that would interfere with electrical and optical signal integrity. Low viscosity allows the fluid to more effectively circulate within the cooling system and around the components, enhancing heat transfer, ensuring uniform cooling, and improving overall cooling efficiency. Being non-toxic means the fluid will have a lower potential for human or environmental harm in case of leaks or spills. A high flash point helps ensure safe operation. The immersion cooling fluid must be compatible with the materials used in the construction of electronic components and cooling systems, to ensure that the fluid does not cause damage or material degradation of the electronic components, seals, gaskets, and other components that come into contact with the fluid. Finally, although performance is the most important consideration, it is also advantageous if cost-effectiveness is as maximized as possible. The fluid should provide a balance between performance and cost, making it a viable option for widespread use in various applications. This includes considering the initial cost of the fluid, as well as its longevity and maintenance requirements.

There may be several coolants which can provide adequate cooling, but only a few will be chemically compatible. Water is an example of a liquid which has highly desirable heat transfer characteristics, but which is generally unsuitable for direct immersion cooling on account of it is electrically conductive. Fluorocarbon liquids (e.g. FC-72, FC-86, FC-77, etc.) are generally considered to be the most suitable liquids for direct immersion cooling, in spite of their poorer thermo-physical properties and regulatory toxicity concerns. The thermal conductivity, specific heat, and heat of vaporization of fluorocarbon coolants are lower than water. These coolants are clear, colorless per-fluorinated liquids with a relatively high density and low viscosity. They also exhibit a high dielectric strength and high-volume resistivity. The boiling points for currently available liquids may be in the range from 30 to 253° C.

### SUMMARY OF THE INVENTION

The present invention is an improved immersion cooling fluid that incorporates White Alkanes with Highly Refined Alkanes producing a unique mixture (“WA-HRA Immersion Cooling Fluid”). The WA-HRA Immersion Cooling Fluid provides high thermal performance, material compatibility and extended operating life. Unlike conventional thermal fluids that rely on non-renewable resources, the WA-HRA Immersion Cooling Fluid utilizes integration of renewable oils derived from sustainable sources, significantly reducing environmental impact, and improving long-term resource availability, offering a greener alternative without compromising performance. Contrary to what might be expected, the inclusion of White Alkanes in the immersion cooling fluid provides superior thermal properties, thermal conductivity, heat transfer efficiency, and stability across a wide range of temperatures.

As used herein, “White Alkane” or “White Alkanes” is hydrocarbon material from renewable sources that are not sourced from petroleum (or crude oil) and that meet all or some of the requirements for being a white mineral oil from a pharmacopoeia as set forth in at least one of the European Pharmacopoeia (Ph. Eur.), United States Pharmacopeia (USP), National Formulary (NF), Japanese Pharmacopoeia (JP), or former monographs of the British Pharmacopoeia (BP), German Pharmacopoeia (also known as the Deutsches Arzneibuch) (DAB), or French Codex (also known as La Pharmacopée Française). White Alkanes are generally liquids (some products are waxy) and has white oil-like characteristics.

WHITE ALKANES, WA, HIGHLY REFINED OILS, HRA, and WA-HRA are trademarks of HollyFrontier LSP Brand Strategies LLC, all rights reserved.

White Alkanes are inert and have all or some of: specified feed materials, carbon chains with a given range of numbers of carbon molecules, viscosities in a given range, UV absorption, aromatics, color, readily carbonizable substances, improved pour points, improved flash points, a clear (or generally clear) appearance, specific gravity/relative density, acidity/alkalinity, and no, or virtually no, sulfur compounds. White Alkanes come from the group comprising: renewable diesel, biodiesel, vegetable oils, polymerized vegetable oils, polymerized fatty acids, polymerized fatty acid esters, triglycerides, diglycerides, monoglycerides, organic esters, naturally occurring oil or material containing 50% or more of unsaturated fatty acid components including mono-, di-, and tri-unsaturated hydrocarbon chains, soy, canola, castor, corn, cottonseed, crambe, linseed, olive, peanut, rapeseed, safflower, sunflower, tall oil fatty acid, coconut, palm; oils derived from seeds, pulp, beans, legumes, rinds, pits or any part of an oil bearing fraction of the intended plant; animal fats or fish oils, or a mixture thereof containing hydrocarbon chains in C12-C100 range for use in various applications, including for personal care products and lubricants.

White Alkanes are the resultant product after subjecting renewable sources to various refining processes.

Conventional, feed materials that are renewable replacements for petroleum based base oils, process fluids, and white oils are usually based on vegetable oils or products derived from chemical modification of vegetable oils such as diesters and polyol esters. These feed materials possess relatively higher reactivity that negatively affects the properties of the final product.

The method of producing White Alkanes is expected to efficiently produce higher purity hydrocarbons from renewable feed materials than other methods of renewable hydrocarbon production. The hydrocarbon material product, White Alkanes, will possess hydrocarbons with most or all of the properties of white mineral oils.

As used herein, “renewable” (which may also be referred to as “renewable sources” or “renewable carbon”) may include renewable diesel, vegetable oils, polymerized vegetable oils, polymerized fatty acids, polymerized fatty acid esters, or a mixture thereof. The renewable carbon in the feed material may be chosen from, in part, the renewable diesel, vegetable oils, polymerized vegetable oils, polymerized fatty acids, polymerized fatty acid esters, or a mixture thereof.

Renewable diesel, also known as green diesel or hydrotreated vegetable oil (HVO), is a type of biofuel that is chemically similar to petroleum diesel but is produced from renewable sources. Renewable diesel is sourced from oils such as vegetable oils, animal fats, recycled cooking oils, and waste oils. Renewable diesel is produced by hydrotreating, or hydroprocessing, the feedstock fats and oils. The process involves treating the feedstock with hydrogen at high temperatures and pressures in the presence of a catalyst, resulting in a product that is chemically similar to petroleum diesel. And produces a fuel that can be used in diesel engines without modification.

Vegetable oils are generally trigylcerides (glycerol esters) which are esters of glycerol and various acid referred to as fatty acids that range from carbon chain lengths of C12-C24 and have additional functional groups such as double bonds, or hydroxyl groups as in castor oil. Vegetable oils are produced in oilseed crops and fruits such as olive or palm, palm kernel and coconut. Alternatively, the feed material is a naturally occurring oil or material containing 50% or more of unsaturated fatty acid components including mono-, di-, and tri-unsaturated hydrocarbon chains, with a majority of their fatty acids in the C16-C22 range. In general, “renewable” or “renewable sources” or “renewable carbon” includes all carbon sources that do not use fossil carbon from the geosphere. Fossil carbon is generally petroleum-or coal, crude oil, and natural gas. Fossil carbon generally comes from decomposing plants and animals and is found in the Earth's crust, and thus comes from the geosphere. In contrast, renewable carbon comes from the biosphere, atmosphere, or technosphere-but not from the geosphere.

White Alkanes are obtained using vegetable oils containing short chain lengths. The sources may be triglycerides and fatty acid components chosen from one or more natural sources such as: soy, canola, castor, corn, cottonseed, crambe, linseed, olive, peanut, rapeseed, safflower, sunflower, tall oil fatty acid, coconut, palm; oils derived from seeds, pulp, beans, legumes, rinds, pits or any part of an oil bearing fraction of the intended plant; animal fats or fish oils, or a mixture thereof. These oils contain 50% or more of unsaturated fatty acid components including mono-, di-, and tri-unsaturated hydrocarbon chains, with a majority of their fatty acids in the C16-C22 range (C18 is typical for vegetable oil) that can be desirable for most applications.

Other naturally occurring oils or materials generally containing unsaturated hydrocarbon chains can also be used. Feed materials containing high levels of saturated hydrocarbon chains will give lower yields of the hydrocarbons usable as base oils, white oils, and process fluids, they will produce higher amount of renewable diesel. For example, animal fat, coconut oil, and palm oil containing a high level of saturation and will produce high amounts of renewable diesel fuel during the process.

The renewable diesel will result in production of hydrocarbons suitable for cooling fluids and finished refined fuels.

Various processes can be used to create the desired white alkanes by further processing renewable diesel. As an example of one of the many manufacturing pathways, the white alkane process flow for cooling fluids begins with converting non-polymerized vegetable oil to renewable diesel through impurity pre-treatment, hydrogenation and isomerization. The resulting renewable diesel is then fractionated to a desired hydrocarbon cut, which is then appropriately purified through different technologies to produce white alkanes.

The resultant substance, White Alkane via renewable diesel, has white oil quality. It is created generally from 50%-100% renewable carbon and hydrocarbon based materials, but in order to produce a higher quality product it is preferable to use 80%-100% renewable carbon and hydrocarbon based materials. The White Alkanes have the same inert hydrocarbon benefits as mineral oil, and White Alkanes are derived from natural ingredients per ISO 16128.

White Alkanes have viscosities in a range (at 40° C.) from 2 cSt to 60 cSt and higher. The preferred viscosity range for immersion cooling application through renewable diesel is 2 cSt to 5 cSt, most preferably 3.0 cSt to 4.5 cSt.

White Alkanes are a white oil quality material and meet some, or all, of the following requirements: UV absorption, aromatics, color, readily carbonizable substances, and other white oil requirements. The percentage of renewable carbon in the White Alkanes is between 50% 100%, although it is more desirable between 80%-100%, and is preferably between 90%-100%. The starting feedstock is selected sources having C12-C100 carbon chains, with significant portion of hydrocarbon chains for renewable diesel being in C12 to C24 range. Paraffins, or alkanes, are saturated hydrocarbons with the general formula CₙH₂ₙ₊₂. White Alkanes are comprised of a mixture of normal (linear) and iso (branched) paraffins, and a small amount (<8%) of cyclo paraffins. The normal paraffins are very important in the WA-HRA Immersion Cooling Fluid due to their excellent thermal performance.

White Alkanes are hydrocarbon with renewable carbon content of between 50% wt to 100% wt, and containing naphthenic and paraffinic carbons in a desired ratio. White Alkanes are similar in quality to white oil and meet the requirements of the quality level set for white mineral oils per USP/NF Compendia, US Food and Drug Administration CFR, European Pharmacopoeia Monographs. The term “White Alkanes” was coined in order to invoke the similarity in characteristics of White Alkanes to White Oil. However, White Alkanes are sourced differently than White Oil, so White Alkanes are not White Oil.

White Alkanes are hydrocarbon material derived from a renewable source of carbon, wherein said renewable source is not petroleum or crude oil, which meets all or some of the requirements for being a white mineral oil from a pharmacopoeia as set forth in at least one of the European Pharmacopoeia (Ph. Eur.), United States Pharmacopeia (USP), National Formulary (NF). White alkanes also have carbon chains generally in a range of C10 to C100.

Alkanes can be described as hydrocarbons, but not all hydrocarbons can meet the requirements of and be classified as alkanes. White oils can be described as alkanes or hydrocarbons, but not all alkanes or hydrocarbons can meet the requirements of and be classified as white oils. White alkanes can be described as alkanes or hydrocarbons, but cannot be described as a white oil as white oils must be petroleum derived, and not all alkanes, hydrocarbons or white oils can meet the requirements of and be classified as a white alkane. Not all materials described as hydrocarbons and alkanes can meet the purity requirements required by the pharmaceutical and cosmetic industry due to levels of impurities and unsaturation of the molecules. Both petroleum and renewable sources of hydrocarbons and alkanes contain impurities and unsaturated molecules. Complex and high levels of processing are required for these molecules to meet the purity requirements.

Highly Refined Alkanes (“HRA”) are fluids containing mostly saturated hydrocarbons, derived from renewable or petroleum sources, including from production (or refining) processes that produce API Group III/III+ base oils, containing low levels of impurities such as S, N, O and aromatics. For the purpose of this invention, Highly Refined Alkanes is used to describe the base fluids that are derived from petroleum sources only and excludes renewable sources. Group III+ typically uses the same refining process as Group III, however the starting material feed contains higher amounts of high VI waxy material. The VI of Group III+ base oil is normally 130 and greater. Gas to liquid hydrocarbons (“GTL”) are considered to be Group III base oils, even though their feed and processing are different. The starting material for GTL is natural gas. HRA may include one or more, and any combination, of: Group III, Group III+, and GTL. It is also anticipated that the WA-HRA Immersion Cooling Fluid may include Group IV base stocks or Polyalphaolefins (PAO) up to 35 % wt in the finished immersion cooling blend. Group IV base stocks are fully synthetic oils made from Polyalphaolefins (PAOs), chemically engineered from precursors like ethylene, resulting in uniform molecules with exceptional thermal stability, high viscosity index (VI>120), and excellent performance in extreme temperatures. Group IV base stocks are full synthetic polyalphaolefins.

The WA-HRA Immersion Cooling Fluid is a breakthrough in the field of thermal fluids/immersion cooling, offering a sustainable solution with unparalleled thermal properties. By integrating White Alkanes into the formulation, a remarkable balance between environmental sustainability, and exceptional thermal performance is achieved. This innovation represents a significant advancement over prior art in thermal fluids, providing a solution that is not only environmentally friendly but also outperforms existing alternatives made with synthetic esters and/or polyalphaolefin (“PAO”). (PAO does not contain ring structures, double bonds, sulfur, nitrogen components or waxy (linear) hydrocarbons. White Alkanes generally have high paraffinic (linear and branched) content. Heat transfer properties are improved with linear alkanes for immersion cooling applications.

The WA-HRA Immersion Cooling Fluid is a fluid mixture that comprises White Alkanes and highly refined alkanes. The WA-HRA Immersion Cooling Fluid's main desirable performance attributes include thermal performance, material compatibility, and purity. In a preferred embodiment, the WA-HRA Immersion Cooling Fluid comprises White Alkanes, in a percent by weight (% wt), anticipated to be in the range of 10% wt to 60% wt of the WA-HRA Immersion Cooling Fluid mixture, and comprises HRA anticipated to be in the range of 40% wt to 90% wt of the WA-HRA Immersion Cooling Fluid mixture. Also in a preferred embodiment, the White Alkanes in the WA-HRA Immersion Cooling Fluid mixture comprises no more than about 6% cycloparaffins, and carbon chains in the range of C 14-C22. White Alkanes comprise said n-paraffins in the range of 8% wt to 17% wt, while in the final cooling fluid n-paraffins in the range of 4.5% wt to 17% wt.

The WA-HRA Immersion Cooling Fluid comprises normal and iso paraffins, and cycloparaffins. Of these, approximately at least 97% are normal and isoparaffins, as can be shown by high resolution mass spectrometry (“HRMS”). The WA constituent contains relatively large amounts of normal alkanes (aka “n-alkanes” or “n-paraffins”). In one embodiment, the White Alkane comprises n-paraffins in the range of 8% to 17% which are most effective for thermal heat removal. In another embodiment, the White Alkane comprises n-paraffins in the range of 9% to 16% which are most effective for thermal heat removal. Having this high content of normal alkanes is difficult to obtain in HRA type refining processes and is even more difficult in PAO processes. The WA-HRA Immersion Cooling Fluid provides the ability to incorporate renewable content in immersion cooling applications and continue to provide high thermal performance, material compatibility and extended operating life. Existing fluids will compromise performance vs. sustainability.

In one embodiment, the WA-HRA Immersion Cooling Fluid comprises White Alkanes, highly refined alkanes, which can comprise one or more of: Group III base oil, Group III+ base oil, gas to liquid hydrocarbons, Group IV base oil, natural esters or synthetic esters. Optionally an additive, or additives, which may include one or more of: an oxidant (which may be a phenolic antioxidant), a wetting agent, a pour point depressant, a fluid flow improver, and/or corrosion inhibitors. In some embodiments, the oxidant may be chosen from one or more of: Benzenepropanoic acid, 3,5-bis(1,1-dimethylethyl)-4-hydroxy-, C7-9 branched alkyl esters, or Butylated hydroxytoluene. Natural esters are organic compounds formed through the reaction of carboxylic acids and alcohols in nature, commonly found in fats, oils, and essential oils. Synthetic esters are man-made through controlled chemical reactions, often designed to mimic or enhance natural properties; they are widely used in industrial applications such as solvents, plasticizers, artificial flavorings, and fragrances. While natural esters are typically biodegradable and part of biological cycles, synthetic esters can be engineered for greater stability, durability, or specific performance.

The present invention is an immersion cooling fluid with increased percentage of linear paraffins having carbon molecule chains in the range of C12-C24. While White Alkanes make the desirable percentage of linear paraffins more possible, the linear percentage is important. In another embodiment, the linear paraffins are in the tight distribution of C14-C22, which has a similar viscosity. Regular mineral oil has a much wider chain length distribution. WA-HRA Immersion Cooling Fluid mixture may have cycloparaffins in the range of 5% wt-40% wt combined with 60% wt-95% wt normal and iso paraffins. The WA sourced from renewable diesel has a pour point substantially in the range of −24 to −3° C.

The WA-HRA Immersion Cooling Fluid has substantially no aromatics in its base oil mixture of normal, iso, and cyclo paraffins from White Alkanes, and normal, iso, and cyclo paraffins from non-White Alkanes. In addition to base oil mixture, the WA-HRA Immersion Cooling Fluid may contain some additives that are used to improve some properties. These additives may include one or more of phenolic antioxidant(s), wettability agents, fluid flow improvers, pour point depressants, and/or corrosion inhibitors.

For immersion cooling fluids, there are three main aspects that are critical for end users: safety, which is related to flash point, fluid handling, and performance. A lower flash point means the product will flash at lower temperatures, so it is less safe in operation compared to higher flash point products. The minimum flash point requirement depends on the operating conditions and could be different for different end users/applications. A lower pour point is desired for handling, but a lower pour point may be counter to heat removal performance. And, performance, which has three (3) main components of its own: heat removal capability/thermal management, compatibility with material/component used in the application, and life of the fluid/oxidation/signal integrity. Heat removal capability/thermal management, which is a function of viscosity (lower is better), thermal conductivity (higher coefficient is better), density (higher is better), and heat capacity (higher coefficient is better) of the fluid. Compatibility of the cooling fluid with the materials/components that are being cooled in the physical application. (It is the fluid's ability to not interfere with component functionality, or component physical characteristics or cause leaching of chemicals into the fluid itself.) For example, it is known that hydrocarbon containing cooling fluids can leach out plasticizers, over the time in use, from computer components (examples: cables, seals, gaskets) which may cause interruption with signal integrity due to the fluid lack of clarity. Consequently, balancing the material compatibility with signal integrity performance requires a fluid to contain the appropriate amount of cycloparaffins content in conjunction with having the best heat removal properties which entails having paraffins with as much normal paraffins content as possible while meeting the desired fluid properties (lowest viscosity, highest flash point and reasonable pour point). The desired cyclo paraffins content for WA-HRA Immersion Cooling Fluid is 5%-40%, or in some embodiments 10%-30%.

The WA-HRA Immersion Cooling Fluid provides the cleanest and driest coolant possible. The importance of having a clean and dry fluid is oxidation stability and longer life performance. In the WA-HRA Immersion Cooling Fluid's drying and cleaning processes, the fluid is dried with sparging dry nitrogen (bubbling pure, dry nitrogen gas through the fluid to remove dissolved oxygen and other unwanted gases) to a typical water content level below 20 ppm. The water content of the fluid is tested using ASTM D1533 and if it is higher than 30 ppm, the drying process is continued until the water content is below specification. A dedicated system and tanks are used for blending the WA-HRA Immersion Cooling Fluid. The fluid may be filtered through a 0.5-micron filter prior to filling of storage tanks and transport. The WA-HRA Immersion Cooling Fluid may be stored and/or shipped under a nitrogen blanket (which continues to remove oxygen and helps prevent combustion, oxidation, water absorption, contamination, and evaporation). For bulk shipment, transfer lines, tank trucks and rail cars are flushed using blended products.

In one embodiment, the White Alkanes in the WA-HRA Immersion Cooling Fluid is ultra-pure with particles removed to the level that a power factor tested at 25° C. of the White Alkanes is less than 0.0001. Power factor (loss tangent/dissipation factor) is a test that is sensitive to impurities such as polar compounds, particles, dust, etc. and is used for verification of having ultra purity.

The WA-HRA Immersion Cooling Fluid may be used for any type or technique of cooling electronics or peripherals, such as direct or indirect.

### BRIEF DESCRIPTION OF THE DRAWINGS

FIG. 1a is a table illustrating a first embodiment of the WA-HRA Immersion Cooling Fluid showing minimum and maximum percentages of constituents in the WA-HRA Immersion Cooling Fluid mixture. In this table, the White Alkanes (“WA”) content is from 10%-60%.

FIG. 1b is a table illustrating a second embodiment of the WA-HRA Immersion Cooling Fluid showing minimum and maximum percentages of constituents in the WA-HRA Immersion Cooling Fluid mixture.

FIG. 2 is a table illustrating a third embodiment of the WA-HRA Immersion Cooling Fluid showing minimum and maximum percentages of constituents in the WA-HRA Immersion Cooling Fluid mixture.

FIG. 3 is a table that illustrates selected characteristics of variations of the White Alkanes.

FIG. 4 illustrates the components of seven (7) embodiments of immersion cooling formulations.

FIG. 5 illustrates a comparison of Heat Rejection Rate versus Mass Flow Rate and temperature for the seven (7) embodiments of immersion cooling formulations.

FIG. 6 illustrates a comparison of Heat Rejection Rate versus Mass Flow Rate and temperature for the seven (7) embodiments of immersion cooling formulations.

FIG. 7 is a table illustrating certain physical properties of the seven (7) embodiments of immersion cooling formulations.

FIG. 8 is a table illustrating certain physical properties of various embodiments of White Alkanes (WA) and HRA A.

FIG. 9 shows three (3) power supply cables to compare damage.

FIG. 10 is a chart illustrating material compatibility comparison between HRA and WA-HRA Immersion Fluids with other type of fluids (PAO, GTL, and Esters).

FIG. 11 compares material compatibility of HRA, WA-HRA and PAO fluids.

FIG. 12, FIG. 13 and FIG. 14 are charts illustrating oxidation stability of various immersion cooling fluids.

FIGS. 15a and 15b are tables from which the data in FIGS. 1a and 2 are extracted.

### DETAILED DESCRIPTION OF THE PREFERRED EMBODIMENT

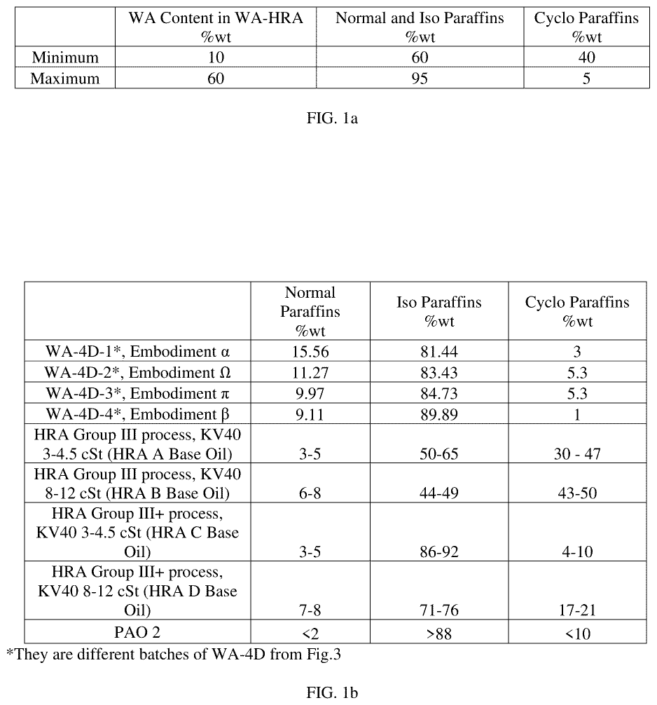

Referring to the figures, FIG. 1a is a table illustrating a first embodiment of the WA-HRA Immersion Cooling Fluid showing minimum and maximum percentages of constituents in the WA-HRA Immersion Cooling Fluid mixture. White Alkanes (“WA”) (White Alkanes are sometimes referred to as “Renewable Base Oil” or “RBO.”) are a necessary component of the WA-HRA Immersion Cooling Fluid. It should be understood that in FIG. 1a there are “minimum” and “maximum” values for the range of percentage of normal, iso and cyclo paraffins in the WA-HRA Immersion Cooling Fluid. The majority of cyclo paraffins in WA-HRA Immersion Cooling Fluids comes from the HRA.

The White Alkanes percentage is a percentage of the total mixture. The fluid is a mixture of White Alkanes plus HRA base oils. The hydrocarbons in the whole mixture include normal paraffins, iso paraffins and cyclo paraffins. In this figure, and in an embodiment, the WA-HRA Immersion Cooling Fluid mixture is comprised of a range of 10%-60% of White Alkanes plus 40%-90% of non-White Alkane oils, which are Highly Refined Alkanes (HRA).

As an example, in one embodiment, the WA-HRA Immersion Cooling Fluid mixture is comprised of 10% of White Alkanes and 90% of non-White Alkane oils (HRA). It could have the following mixture breakdown: approximately 60% normal paraffins and iso paraffins plus approximately as much as 40% cycloparaffins. In this embodiment, the normal and iso paraffins are comprised of approximately 9.5% normal and iso paraffins from White Alkanes and approximately 50.5% of normal and iso paraffins from non-White Alkane (HRA) sources, and approximately 0.5% cyclo paraffins from White Alkanes and approximately 39.5% cyclo paraffins from non-White Alkane (HRA) sources.

In another embodiment, the WA-HRA Immersion Cooling Fluid mixture is comprised of 60% White Alkanes plus 40% of oils from non-White Alkane (HRA) sources. It could have the following mixture breakdown when using group III+ processed HRA: approximately 95% normal paraffins and iso paraffins plus approximately 5% cycloparaffins. In this embodiment, the normal and iso paraffins are comprised of approximately 57% normal and iso paraffins from White Alkanes and approximately 38% non-White Alkane (HRA) normal and iso paraffins, and approximately 3% cyclo paraffins from White Alkanes and approximately 2% non-White Alkane (HRA) cyclo paraffins.

White Alkanes, which are derived from renewable oils, have higher n-paraffins in comparison to mineral oils (HRA) and PAOs as shown in FIG. 1b. N-paraffins have much better heat transfer properties compared to iso and cyclo paraffins, as they have more degrees of freedom to absorb the phonons, heat particles off the solid surface, and take into the bulk liquid.

FIG. 1b is a table illustrating a second embodiment of the WA-HRA Immersion Cooling Fluid showing of the estimated normal paraffins, iso paraffins and cyclo paraffins (calculated from ASTM D5442 modified-GC FID) in different samples of White Alkane base oils (WA-4D-1 (Embodiment α), WA-4D-2 (Embodiment Ω), WA-4D-3 (Embodiment π) and WA-4D-4 (Embodiment β)), HRA base oils and PAO. WA-4D-1, WA-4D-2/WA-4D-3 and WA-4D-4 are from three different batches of production, while WA-4D-2 and WA-4D-3 are from different containers and the same batch. The WA-4D-4 was processed at a different location. The WA has a pour point substantially in the range of −24 to −3° C. Conventional immersion fluids typically strive for a very low amount of linear paraffins due to the desirability of a lower pour point e.g. in handling for winter or shipping on aircraft at high altitudes. The WA-HRA Immersion Cooling Fluid balanced mixture seeks to maximize all performance metrics using a high White Alkane linear paraffin content. HRA base oils used in this invention are from Group III and III+ processes. The kinematic viscosity ranges for the main base oils are 8.0 to 12.0 cSt and 3.0-4.5 cSt at 40° C. White Alkane has a kinematic viscosity at 40° C. of 3 cSt to 5.5 cSt.

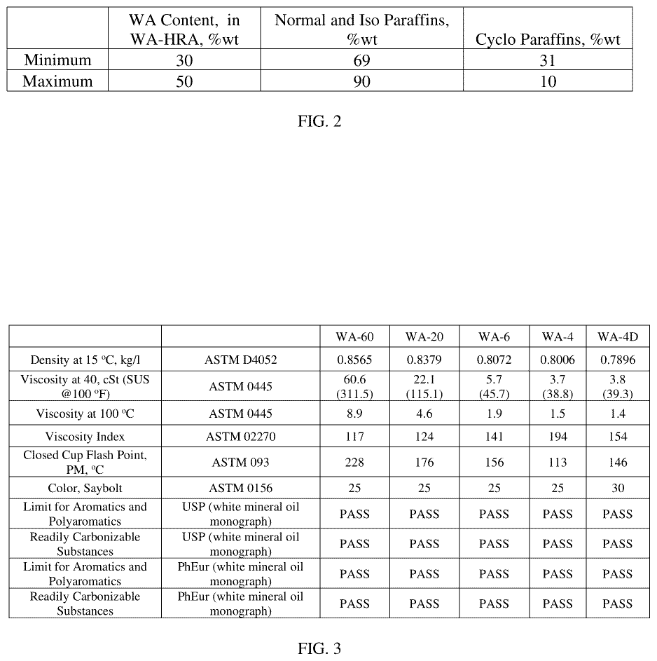

FIG. 2 is a table illustrating a third embodiment of the WA Cooling Fluid showing a preferred range for minimum and maximum percentages of constituents in the WA-HRA Immersion Cooling Fluid mixture. In this embodiment, the WA-HRA Immersion Cooling Fluid contains approximately 10%-60% White Alkanes and 50%-70% constituents from non-White Alkane (HRA) sources. In this embodiment, normal and iso paraffins from White Alkanes and non-White Alkanes (HRA) are the range of approximately 69%-90%, while cyclo paraffins from White Alkanes and non-White Alkanes (HRA) are the range of approximately 10%-31%.

In the WA-HRA Immersion Cooling Fluid, branched hydrocarbons provide lifetime cleanliness through oxidative stability and cyclic hydrocarbons provide solubility balance. Linear paraffins tend to be long chain and bulky. They are nonpolar and hence do not easily mix with polar liquids such as water, making them less soluble than other hydrocarbons. Cyclo paraffins'cyclic structure makes them more polar and hence more soluble. The enduring cleanliness of the WA-HRA Immersion Cooling Fluid ensures minimal alterations in fluid properties over time, including dielectric constant and loss tangent at high frequencies. This reliability guarantees signal integrity throughout the fluid's lifetime.

FIG. 3 is a table that illustrates selected characteristics of variations of the White Alkanes (“WA”). WA-4D is the White Alkane produced from renewable diesel which is used in WA-HRA fluids. WA-4D is the source for WA-4D-1 (Embodiment α), WA-4D-2 (Embodiment (Ω), WA-4D-3 (Embodiment π) and WA-4D-4 (Embodiment β).

White Alkane is a refined oil that is generally colorless and odorless. It is derived from renewable sources and undergoes a unique purification process to remove impurities. White Alkane is created from generally 50%-100% renewable carbon and hydrocarbon-based materials, but in order to produce a higher quality product an embodiment uses between 80%-100%, and another embodiment uses between 90%-100% renewable carbon and hydrocarbon based materials. The key characteristics of White Alkanes include high purity, colorless, non-reactive, oxidation resistance, viscosity consistency, and non-toxic. The WA via renewable diesel has a pour point substantially in the range of −24 to −3° C.

The viscosity range of the White Alkanes product should meet, but not be limited to:
a. US Pharmacopoeia USP <911> for Mineral Oil: 34.5-150.0 cSt;
b. Light Mineral Oil: 3.0-34.4 cSt;
c. European Pharmacopoeia Ph. EUR. <2.2.9>: P. Liquidium: 110-230 mPa-s (millipascal-second) (Dynamic viscosity is the resistance to movement of one layer of a fluid over another and may be measured using the Pascal second.); and
d. P. Subliquidium: 25-80 mPa-s.

Other characteristics of the White Alkanes include, without limitation, a specific gravity/relative density that meets the requirements of United States Pharmacopoeia per USP/NF <841> and meets the requirements of European Pharmacopoeia Ph. Eur. <2.2.5>. The acidity/alkalinity of the White Alkanes should meet the requirements of US Pharmacopoeia USP/National Formulary (NF) <M02> and European Pharmacopoeia Ph. Eur. <M01>. The White Alkanes have no, or virtually no, sulfur compounds, and meets the requirements of US Pharmacopoeia and FDA USP/NF <M04>. The White Alkanes also meet the requirements for ultraviolet (UV) absorption and Saybolt color found in 21 CFR 178.3620 (and for Saybolt color in the requirements of FDA test per ASTM D156). The White Alkanes is a hydrocarbon with renewable carbon content of between than 50% to 100% and containing naphthenic and paraffinic carbons in a desired ratio. The White Alkanes is similar in quality to white oil and meets the requirements of the quality level set for white mineral oils per USP/NF Compendia, US Food and Drug Administration CFR, European Pharmacopoeia Monographs. Some grades may not meet the Solid paraffin requirements as they may not be critical for all applications. But the White Alkanes meets the requirements for food additives of the Food and Drug Administration (FDA) per 21 CFR 172.878.

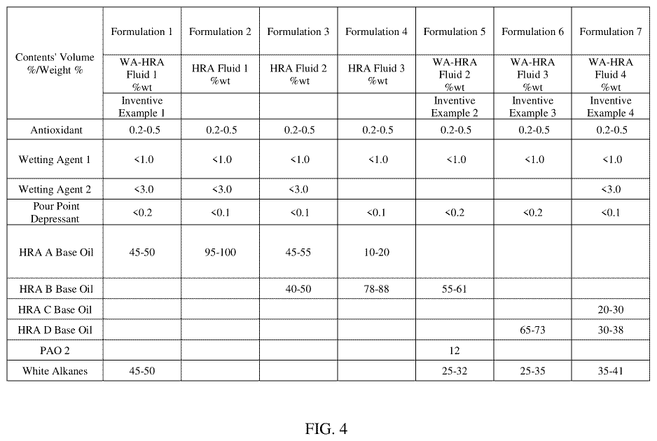

FIG. 4 illustrates formulation details for Formulation 1, Formulation 2, Formulation 3, and Formulation 4. As shown, Formulation 1 (WA-HRA Immersion Cooling Fluid) contains White Alkanes, while the other formulations do not. The WA-HRA Immersion Cooling Fluid works as a result of the base fluids with a combination of additives selected to impart oxidation stability (antioxidant), low temperature performance (pour point depressant), and increased wetting performance.

The WA-HRA Immersion Cooling Fluid may contain various additives, and amounts of those additives, to improve various properties. The additives may include one or more (or none) of: phenolic antioxidant(s), wettability agents, fluid flow improvers, pour point depressants, and/or corrosion inhibitors. This table illustrates some of the embodiments that include various of these additives.

The WA-HRA Immersion Cooling Fluid, where it contains some Cyclo paraffins'cyclic structure, makes them more polar than linear paraffins (which are generally non-polar) and hence increases their solubility. This can be important because, in application, the WA-HRA Immersion Cooling Fluid comes into contact with a variety of components and materials (e.g. gaskets and cable housings). Components such as plastics can oxidize and degrade. For example, a gasket might shrink. It is advantageous for the component to absorb a small amount of the WA-HRA Immersion Cooling Fluid so that the gasket does not shrink, rather it may expand slightly. However, too much of the cyclo paraffins can provide too much solubility and expand more than desirable causing leaching and other problems. Thus, embodiments of the WA-HRA Immersion Cooling Fluid may have an amount of cyclo paraffins that allows for some solubility, but not too much. The WA-HRA Immersion Cooling Fluids should contain a range of approximately between 5.0 % wt to 40.0 % wt and more preferably 10.0 % wt to 30.0 % wt to provide optimal overall immersion cooling performance.

Immersion fluids are often exposed to elevated temperatures during use. The heat can cause the immersion fluid to degrade over time, reducing its effectiveness and possibly leading to equipment failure. An antioxidant works to prevent the oxidation process that can lead to the degradation of the immersion fluid. The antioxidant chosen for WA-HRA Immersion Cooling Fluids is a phenolic antioxidant from the following: Benzenepropanoic acid, 3,5-bis(1,1-dimethylethyl)-4-hydroxy-, C7-9 branched alkyl esters, Benzenepropanoic acid, 3,5-bis(1,1-dimethylethyl)-4-hydroxy-, n-butyl ester, Butylated hydroxytoluene (“DBPC”), 2,6-di-tert-butylphenol, 4,4′-Methylenebis(2,6-DI-tert-butylphenol), or 2,6-di-tert-butyl-p-cresol, may be used in the WA-HRA Immersion Cooling Fluid as an antioxidant in some embodiments of the WA-HRA Immersion Cooling Fluid.

The nature of immersion cooling is that electrical components and materials (e.g. servers, storage, networking, power supplies, etc.) may come into contact with, and be wetted by, the WA-HRA Immersion Cooling Fluid. A wetting agent may aid the wetting of the components by the WA-HRA Immersion Cooling Fluid by lowering its surface tension in order to increase the spreading and penetrating properties of the WA-HRA Immersion Cooling Fluid. Embodiments illustrated of the WA-HRA Immersion Cooling Fluid in this table use one or more of the following wetting agents in small amount: Ethylhexyl Sebacate, Ethylhexyl Azelate, Ethylhexyl Laurate, fatty acid mono ester such as 2-ethylhexyl stearate, Adipates such as Di 2 ethylhexyl adipate or Di-iso-octyl adipate, Di-n-hexyl ether, Di-n-octyl ether or Polyisobutylene in the range of molecular weight 200-400 for their high penetration and spreading effects.

Pour point depressants help inhibit wax crystal and gel formation. Embodiments of the WA-HRA Immersion Cooling Fluid may include a pour point depressant and embodiments illustrated in this table includes Polymethacrylates, Polyacrylates, Polystyrene, or Maleic anhydride-styrene copolymer.

Embodiments of the WA-HRA Immersion Cooling Fluid also may include some amount of Highly Refined Alkanes. Embodiments of the WA-HRA Immersion Cooling Fluid illustrated in this table include the Highly Refined Alkane (HRA) A and B. Thus, it is anticipated that the WA-HRA Immersion Cooling Fluid may have a combination of HRA and White Alkanes.

All formulations presented in FIG. 4 were tested in a heat transfer rig.

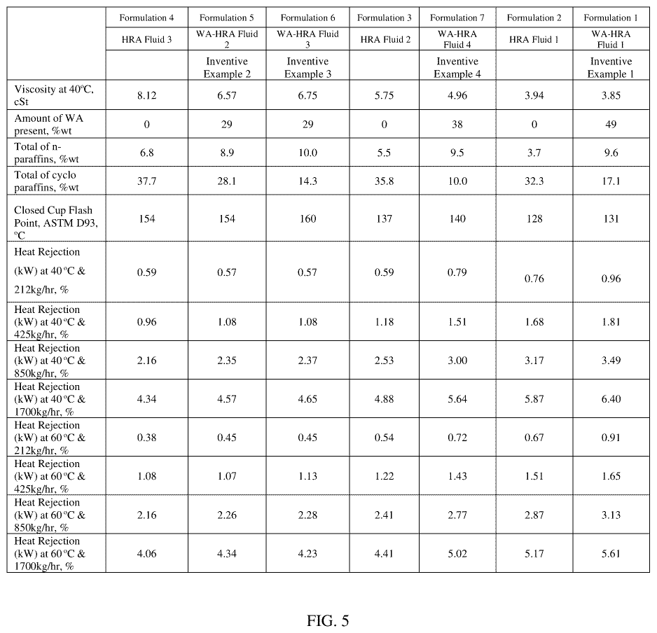

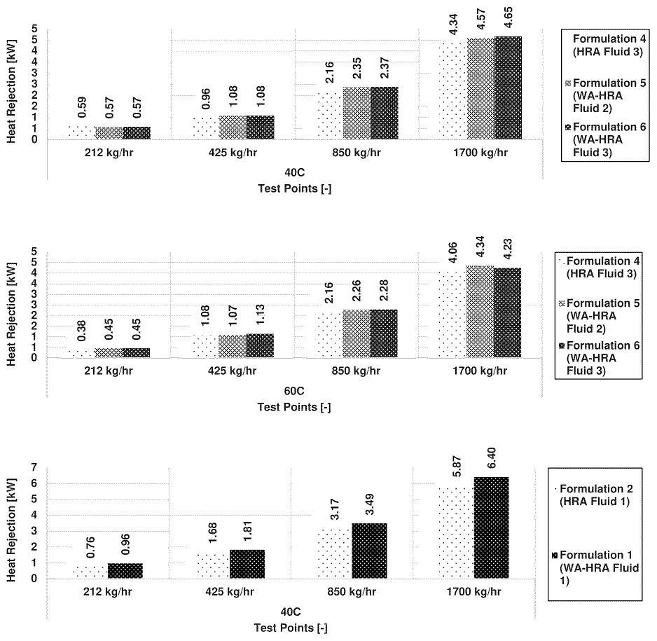

FIG. 5 compares Heat Rejection Rate at two different temperatures (40° C. and 60° C.) at four different flow rates (212, 425, 850 and 1700 kg/hr). The heat transfer rig is a tool to investigate and understand the convective heat transfer performance of different fluids. It consists of an experimental setup to measure cold fluid flowing through a horizontal hot pipe. Each fluid was flushed using a single fill-and-drain with a neutral flush fluid; no naphtha was used to avoid premature valve and pump seal degradation. The system was then filled once with the test coolant, approximately 850 0mL. Testing was conducted with the pipe temperature held constant at 120° C. Two inlet fluid temperatures (40 and 60° C.) were swept, and at each temperature, four flow rates—212, 425, 850, and 1700 kg/hr—were tested. This full matrix was repeated three times. At a 10-second measurement interval, data was recorded at a rate of 10 Hz, resulting in averages calculated over 100 data points per 10-second period. For the full test matrix, which consisted of testing 2 inlet temperatures (40 and 60° C.) at 4 flow rates (212, 425, 850, and 1700 kg/hr) and repeated 3 times, the total test duration was approximately 18 hours. The same process was repeated for each new test fluid.

The heat rejection rate refers to the amount of heat energy being expelled by a system, measured in kilowatts (kW), indicating how much heat is being transferred away from a system per unit time. The heat rejection rate basically expresses how much heat is being expelled to the surrounding environment. The mass flow rate in kg/hr represents the amount of mass (in kilograms) that flows through a given point per hour, essentially measuring how much substance passes by in a specific time frame.

FIG. 5 is a table that ranks seven (7) different formulations of cooling fluids, and compares the heat rejection rate of formulations with comparable flash point at varying mass flow rates, and at two (2) different temperatures: 40° C., and 60° C. While the heat rejection rate changed under the varying conditions, the ranking of the fluids remained consistent with the heat transfer coefficient results. Across both fluid temperatures (40° C., and 60° C.), formulations with WA consistently exhibited higher heat rejection rate compared to formulations with HRA and with comparable flash point for all mass flow rates. Formulation 1 (WA-HRA Fluid 1 (Inventive example 1)) had approximately an 8% higher heat rejection rate than Formulation 2 (HRA Fluid 1) with 425 kg/hr mass flow rate and at 40° C. fluid inlet temperature. Formulation 5 (WA-HRA Fluid 2) and Formulation 6 (WA-HRA Fluid 3) had approximately a 12.5% higher heat rejection rate than Formulation 4 (HRA Fluid 3) with 425 kg/hr mass flow rate and at 40° C. fluid inlet temperature. Formulation 7 (WA-HRA Fluid 4) had approximately a 28% higher heat rejection rate than Formulation 3 (HRA Fluid 2) with 425 kg/hr mass flow rate and at 40° C. fluid inlet temperature.

As shown in FIG. 4, Formulation 1 (WA-HRA Fluid 1), Formulation 5 (WA-HRA Fluid 2), Formulation 6 (WA-HRA Fluid 3), and Formulation 7 (WA-HRA Fluid 4) are immersion cooling fluids that contains White Alkanes, while Formulation 2 (HRA Fluid 1), Formulation 3 (HRA Fluid 2), and Formulation 4 (HRA Fluid 3) do not. FIG. 5 indicates Formulations with White Alkanes consistently exhibited higher heat rejection compared to the ones without White Alkanes and similar flash point. For example, at 40° C. and 425 kg/hr, Formulation 1 had 8% higher heat rejection compared to Formulation 2 which is due to the differences in molecular structure (more linear alkanes). It is important to note that Formulation 1 and Formulation 2 have similar viscosity. FIG. 5 shows that Formulation 1 consistently exhibited higher heat rejection than Formulation 2 under all conditions. FIG. 5 also shows that Formulations 5 and 6 consistently had higher heat rejection than Formulation 3, with the same trend observed for Formulations 7 and 4. Consequently, the White Alkane portion of the cooling fluid is producing better performance. Linear hydrocarbons and to lesser extent branched hydrocarbons are better in terms of heat transfer properties compared to cyclic hydrocarbons. The advantages of higher amounts of linear hydrocarbons and lower cyclic hydrocarbons in the WA-HRA Immersion Cooling Fluid are key to heat transfer.

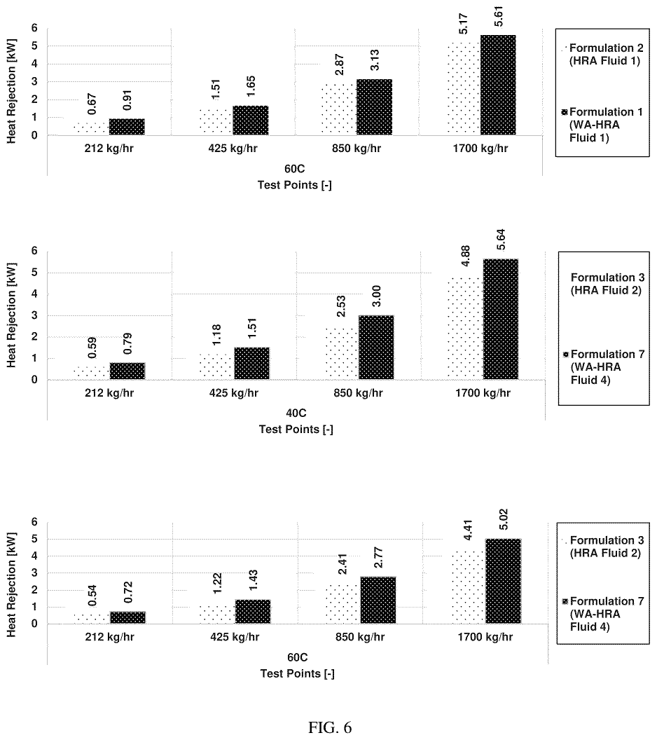

FIG. 6 consists of bar graphs that compare the heat rejection rate of formulations with comparable flash points at varying mass flow rates, and at two (2) different temperatures: 40° C., and 60° C.

However, linear and branched hydrocarbons may cause incompatibility with certain seals due to their lower solubility or absorption into the seal material. Cyclic hydrocarbons have higher solubility or absorption with some seal materials. With excessive linear and branched hydrocarbons, seal materials can get stiff and brittle after soaking in the oil or after aging, which is the disadvantage of linear and branched hydrocarbons. With excessive cyclic hydrocarbons, seal materials can swell or leach after soaking in oil. In order to best deal with these issues, the WA-HRA Immersion Cooling Fluid has relatively more linear hydrocarbons which improves the heat transfer properties, and it has a small number of cyclic hydrocarbons to have adequate solubility.

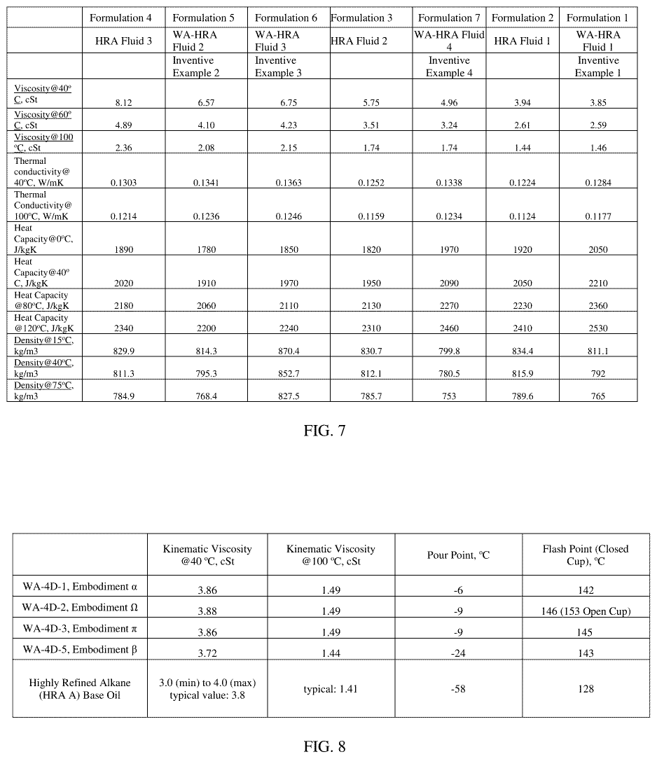

FIG. 7 is a table illustrating certain physical properties of various immersion cooling fluid formulations at various temperatures. Performance of the immersion cooling fluid is in large part determined by its heat removal capability/thermal management. The listed key thermal management properties in order of importance are viscosity followed by heat capacity and then thermal conductivity and density. For an immersion cooling fluid, it is advantageous to target density (higher is better), thermal conductivity (higher coefficient is better), viscosity (lower is better), and heat capacity (higher coefficient is better). In the example formulations, Formulation 1 (the formulation containing White Alkanes, WA-HRA Fluid 1) is shown to have the lowest viscosity and the highest heat capacity. Overall, with similar formulations, the Cooling Fluids with WA stand out as the overall best formulations. For example, the efficacy of the WA-HRA Immersion Cooling Fluid is highlighted by Formulation 1 being closest to Formulation 3 (HRA Fluid 2) in the component mixture, but the inclusion of the White Alkanes provides Formulation 1 (WA-HRA Fluid 1) with superior characteristics as compared to Formulation 3 (HRA Fluid 2).

The molecular structure of a fluid directly influences its heat-transfer properties. Therefore, to isolate the effect of molecular structure, it is best to compare fluids that have similar viscosities and flash points. This reduces the influence of viscosity and carbon-chain length (which correlates with flash point) on the results. Formulation 2 (which does not contain White Alkanes, HRA Fluid 1) is the candidate which is close to Formulation 1 (which contains White Alkanes, WA-HRA Fluid 1) in terms of viscosity properties. FIG. 7 shows that heat capacity and thermal conductivity of Formulation 1 (WA-HRA Fluid 1) is higher (better) than Formulation 2 (HRA Fluid 1). There is a 4.6% improvement in thermal conductivity and 7.2% improvement in heat capacity at 40° C. with Formulation 1 (WA-HRA Fluid 1) despite it having slightly lower density. Higher density fluids tend to have better heat rejection; however, in this case the improvement in thermal conductivity and heat capacity of Formulation 1 (WA-HRA Fluid 1) overrides the negative impact of density.

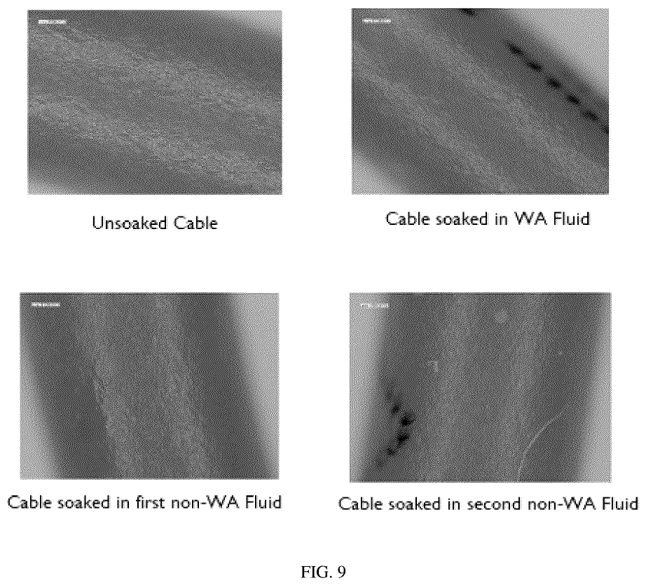

FIG. 8 is a table illustrating certain physical properties of WA-4D-1, WA-4D-2, WA-4D-3, WA-4D-4 and HRA A. Flash point is a function of viscosity and molecular structure. Lower viscosity fluids have lower flash points. Linear molecules with the same carbon length will have a lower flash than a branched alkane or alkyl cyclic structures. Lower viscosity means better heat removal capability, especially when there is any amount of fluid flow. Heat capacity and thermal conductivity are intrinsic properties of the oil. They are functions of molecular structure, carbon chain and type of oil. Renewable base oils (White Alkane base oils) have better thermal conductivity and heat capacity in comparison to the same viscosity mineral oils (Highly Refined Alkanes, HRA), because they contain far less quantities of cyclic molecules, almost similar to polyalphaolefin oils, and they possess a significant amount of normal paraffins, almost absent in polyalphaolefin oils. Renewable oils (White Alkane base oils) provide better/higher flash point in comparison to the same viscosity mineral oil (Highly Refined Alkanes, HRA) because they are of more narrow carbon cut. WA-4D-1, WA-4D-2/WA-4D-3, and WA-4D-4 are from three different batches of production, while WA-4D-2 and WA-4D-3 are from different containers and the same batch. WA-4D-4 was processed at a different location.

White Alkanes have higher pour point properties due to the increased amount of linear paraffins as well as having a narrow carbon distribution, which creates limitations for using them in too high of a percentage in the final immersion cooling fluids. While it is anticipated that White Alkanes could be used in an immersion cooling fluid in an amount up to 100%, a preferred embodiment uses no more than 60 % wt White Alkanes, containing 8.0 % wt to 17.0 % wt normal paraffins in the final blend which tends to provide more advantageous cooling fluid properties overall.

Immersion cooling fluids with higher purity (less polar and aromatics) are better fits for the application. Impurities make the fluid unstable which causes by-products/polar compounds to be produced when the fluid is in service due to high temperatures and operating conditions. By-products can change the dielectric constant, loss tangent and refractive index of the fluid. The change in these parameters has an impact on electrical and optical signal integrity of the medium which has an impact on the performance of IT components (transmitters and receivers). In addition, the presence of any amount of water contamination is undesirable for the same reasons; hence, a drying process is best when making the final immersion cooling fluid product.

FIG. 9 shows three (3) power supply cables viewed under an optical microscope using 150X magnification after they were soaked (one (1) in each fluid) in WA-HRA Immersion Cooling Fluid and two non-White Alkane cooling fluids (HRA Fluids) at 80° C. for two (2) weeks, and one (1) power supply cable was not soaked. Linear and branched hydrocarbons may cause incompatibility with certain material due to their lower solubility/absorption into the material. Cyclic hydrocarbons have higher solubility/absorption with some materials. The WA-HRA Immersion Cooling Fluid has relatively more linear hydrocarbons which improves the heat transfer properties, and it has a small number of cyclic hydrocarbons to have adequate solubility. When these similar power supply cables were soaked in WA-HRA Immersion Cooling Fluid and two non-White Alkane cooling fluids (HRA Fluids), the cables (under an optical microscope using 150 magnification) did not display any damage/cracking and no difference between the cables soaked in the oils and the original cable.

Material compatibility of HRA Fluid 3 and WA-HRA Fluid 2 was studied on 7 different materials commonly used in immersion cooling data centers. The test was conducted at 80° C. for 2 weeks. After the test, the volume, mass, and hardness of the material were measured and compared with the values before the test.

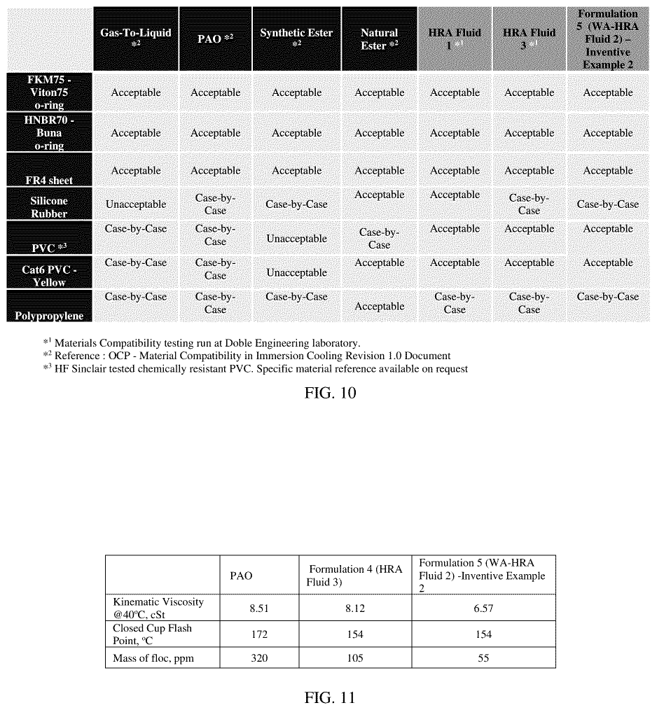

FIG. 10 shows a comparison between HRA and WA-HRA Immersion Fluids with other types of fluids (PAO, GTL and Esters) for this application. The data shows that the material compatibility of WA-HRA Immersion Fluids is comparable to HRA Fluids, and both are better than PAO and GTL fluids.

Material compatibility of HRA Fluid 3, WA-HRA Fluid 2 and a PAO sample was studied on a CAT 6 Polyurethane cable which is recommended for use in immersion cooling. The compatibility test was conducted at 80° C. for two weeks. After testing, all fluids appeared hazy, though to varying degrees. The samples were then analyzed to quantify the mass of floc. The clear top layers were first decanted into separate 16 ml vials. The bottom flocs were washed three times with 10 mL hexane, transferred into another set of 16 ml vials, centrifuged, decanted, dried, and weighed. Floc concentrations were calculated based on the original 40 mL sample volumes.

The results, shown in FIG. 11, indicate that the WA-HRA Fluid had the lowest amount of floc and leaching followed by HRA Fluid, and both were far better than PAO Fluid. This is due to right amount of cycloparaffin content present in the fluid. This is important for fluid longevity, especially for providing better signal integrity performance for GPU based servers used in AI applications.

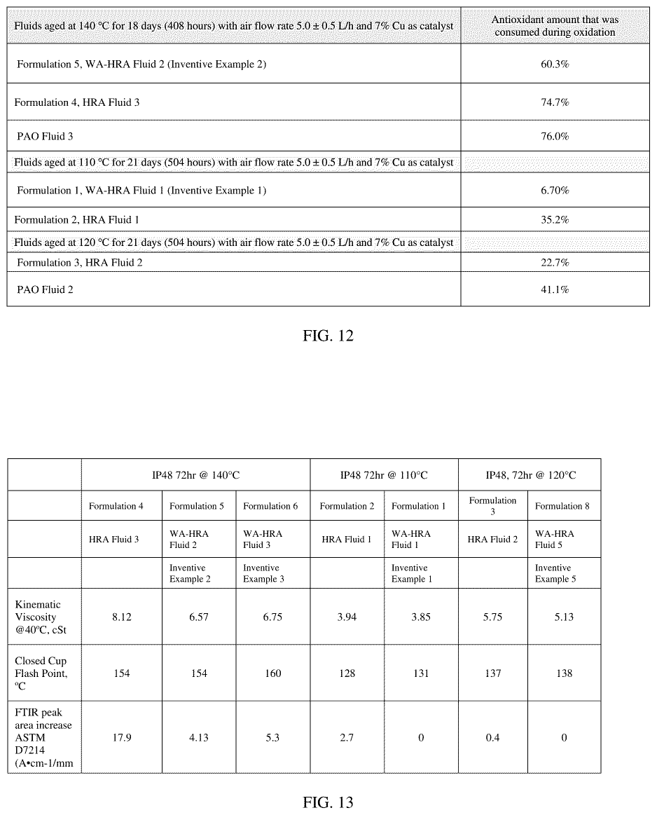

FIG. 12 is a chart illustrating oxidation stability of the WA-HRA Immersion Cooling Fluid compared to non-White Alkane fluids (HRA Fluids). The aging test is a modified DKA (test method CEC L-48-00) with the addition of copper. The results indicate that the WA-HRA Immersion Cooling Fluid exhibited less antioxidant consumption (thus better oxidation stability) than non-White Alkane fluids (HRA Fluids). The better oxidation stability means that the WA-HRA Immersion Cooling Fluid will have better longevity, fluid optical clarity and electrical signal integrity.

FIG. 13 is a chart illustrating oxidation stability of the WA-HRA Immersion Cooling Fluid compared to non-White Alkane fluids (HRA Fluids) using IP48 oxidation test method. The IP48 test measures a lubricant's tendency to form deposits when exposed to air at high temperatures, indicating its thermal and oxidative stability. Samples with similar flash points were run at the same temperature and compared together. Temperatures were chosen for safety reasons, oxidation temperatures at least 10° C. below the flash point of the samples compared. FTIR results are shown in FIG. 13. The higher peak increase means more oxidation by products. The results show WA-HRA Immersion Cooling Fluids have better stability and resistance to oxidation for better longevity, fluid optical clarity and electrical signal integrity.

FIG. 14 is a chart illustrating oxidation stability of the WA-HRA Immersion Cooling Fluid compared to non-White Alkane fluids (HRA Fluids) using PDSC (Pressure Differential Scanning Calorimetry) method. PDSC is a thermal analysis technique used to evaluate the oxidative stability of oils, lubricants, and organic materials under elevated temperature and oxygen pressure. In the test, a small sample is heated at a controlled rate while exposed to pressurized oxygen, and the instrument measures the exothermic heat flow from oxidation reactions. The key result is the induction time, the time before rapid oxidation begins, which indicates the sample's resistance to oxidation. Longer induction times reflect better oxidative stability. The results show WA-HRA Immersion Cooling Fluids have better stability and resistance to oxidation compared to the similar non-White Alkane fluids (HRA Fluids) in terms of viscosity and flash point.

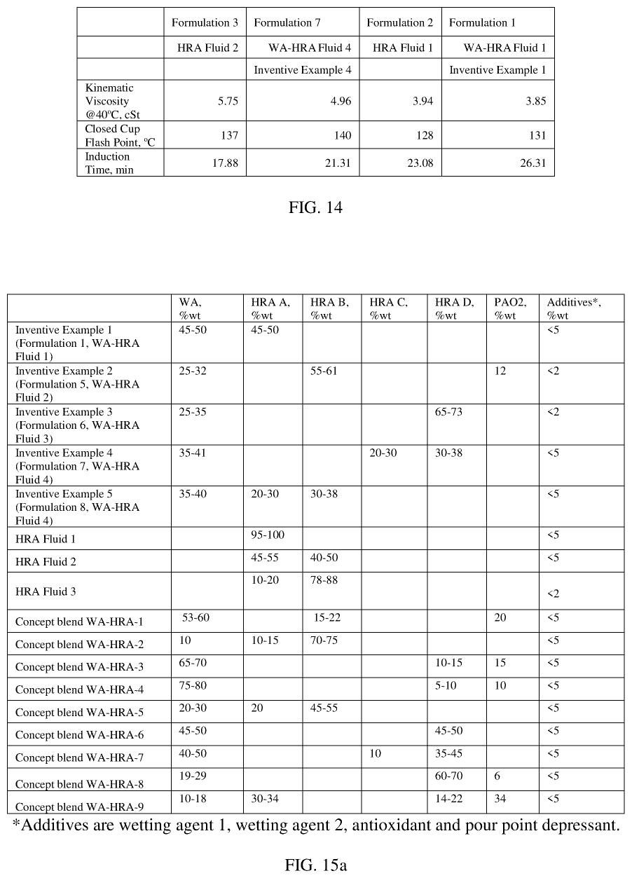

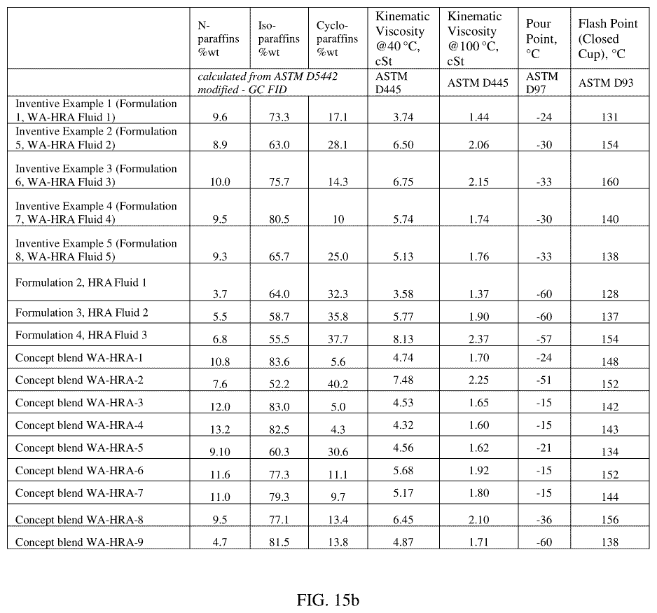

FIG. 15a and FIG. 15b are tables from which the data in FIG. 1a, and 2 are extracted.

Unless otherwise specifically noted, the elements and articles depicted in the drawings are drawn to scale for particular embodiments and illustrative of still other embodiments. The drawings demonstrate examples of the described, mentioned, and/or suggested embodiments and are intended to disclose the elements and articles illustrated as part of the specification. Unless otherwise specifically noted or context indicates, the elements and articles depicted in the drawings are not drawn to scale for particular embodiments. However, even if not to scale, the drawings indicate relative size, angles, shapes, arrangement, orientation, placement, and like information to one of ordinary skill in the art regarding the elements and articles in the drawings. The drawings are intended to disclose the elements and articles illustrated in them as part of the specification. As noted, or if the context indicates, the elements and articles depicted in the drawings are drawn to scale for particular embodiments and illustrative of still other embodiments.

If a hyphenated form of a reference numeral is used, it refers to a specific instance of an element, and the un-hyphenated form of the reference numeral refers to the element generically or collectively. Thus, for example, widget 12-1 would refer to a specific widget out of a number of widgets of a widget class 12, while the class of widgets may be referred to collectively as widgets 12 and any one of which may be referred to generically as a widget 12.

As used herein, the phrases “in certain embodiments,” “in various embodiments,” “in an embodiment,” “in one embodiment, or “in example,” which may each refer to one or more of the same or different embodiment. Furthermore, the terms “comprising,” “including,” “having,” and the like, as used with respect to embodiments of the present disclosure, are synonymous. The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “plurality” and “multiplicity” as used herein refer more than one (1) items or components.

As used herein, “removably attached,” “removably coupled,” “removably,” “removable,” or the like mean that a first object that is coupled, engaged, or attached to a second object may be decoupled from the second object, or taken away from an attached position relative to the second object, using some force or movement. “Removably attached,” “removably coupled,” “removably,” “removable,” or the like further mean that if the first object is not coupled with the second object, the first object may be coupled to the second object or returned to the attached position, using some force or movement. Both the decoupling and the coupling may be accomplished without damaging or altering the functionality of either the first object or the second object.

The terms “substantially,” “approximately,” “about,” or “generally” are defined as being close to as understood by one of ordinary skill in the art. When the terms “substantially,” “approximately,” “about,” or “generally” are used herein to modify a numeric value, range of numeric values, or list numeric values, the term modifies each of the numerals. Unless otherwise indicated, all numbers expressing quantities, units, percentages, and the like used in the present specification and associated claims are to be understood as being modified in all instances by the terms “approximately,” “about,” and “generally.” As used herein, the term “approximately” encompasses +/−5 of each numerical value. For example, if the numerical value is “approximately 80,” then it can be 80+/−5 , equivalent to 75 to 85. As used herein, the term “about” encompasses +/−10 of each numerical value. For example, if the numerical value is “about 80,” then it can be 80+/−10 , equivalent to 70 to 90. As used herein, the term “generally” encompasses +/−15 of each numerical value. For example, if the numerical value is “about 80,” then it can be 80% +/−15, equivalent to 65 to 95. Accordingly, unless indicated to the contrary, the numerical parameters (regardless of the units) set forth in the following specification and attached claims are approximations that may vary depending upon the desired properties sought to be obtained by the exemplary embodiments described herein. In some ranges, it is possible that some of the lower limits (as modified) may be greater than some of the upper limits (as modified), but one skilled in the art will recognize that the selected subset will require the selection of an upper limit in excess of the selected lower limit.

At the very least, and not limiting the application of the doctrine of equivalents to the scope of the claim, each numerical parameter should at least be construed in light of the number of reported significant digits and by applying ordinary rounding techniques.

When the terms “substantially,” “approximately,” or “generally” are used herein not to modify a numeric value, range of numeric values, or list numeric values, the term modifies the state or status of the thing being described. Thus, if widget A is substantially the same as widget B, then widget A is to a great or significant extent, is for the most part, or is essentially the same as widget B. If widget A is approximately the same as widget B, then widget A is not completely or exactly the same as widget B, but is roughly or reasonably close to the same as widget B. If widget A is generally the same as widget B, then widget A is not completely or exactly the same as widget B, but is in most ways the same as widget B.

The terms “inhibiting” or “reducing” or any variation of these terms refer to any measurable decrease, or complete inhibition, of a desired result. The terms “promote” or “increase” or any variation of these terms includes any measurable increase, or completion, of a desired result.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set, or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether they are currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

We claim:

1. A WA-HRA immersion cooling fluid comprising:
White Alkanes;
highly refined alkanes;
wherein said WA-HRA immersion cooling fluid further comprises n-paraffins, isoparaffins, and cycloparaffins.

2. The WA-HRA immersion cooling fluid of claim 1, wherein said WA-HRA immersion cooling fluid is a direct single phase cooling fluid.

3. The WA-HRA immersion cooling fluid of claim 1, wherein said WA-HRA immersion cooling fluid comprises White Alkanes in the range of 10% wt to 60% wt.

4. The WA-HRA immersion cooling fluid of claim 1, wherein said White Alkanes comprise:
said n-paraffins in the range of 8% wt to 17% wt;
said cycloparaffins in the range of 0% wt to 6% wt; and
said carbon chains in the range of C12 to C24.

5. The WA-HRA immersion cooling fluid of claim 3, wherein said White Alkanes comprise:
said n-paraffins in the range of 8% wt to 17% wt;
said cycloparaffins in the range of 0% wt to 6% wt; and
said carbon chains in the range of C12 to C24.

6. The WA-HRA immersion cooling fluid of claim 1, wherein said White Alkanes comprise:
said n-paraffins in the range of 9% wt to 16% wt;
said cycloparaffins in the range of 0% wt to 6% wt; and
said carbon chains in the range of C12 to C24.

7. The WA-HRA immersion cooling fluid of claim 3, wherein said White Alkanes comprise:
said n-paraffins in the range of 9% wt to 16% wt;
said cycloparaffins in the range of 0% wt to 6% wt; and
said carbon chains in the range of C12 to C24.

8. The WA-HRA immersion cooling fluid of claim 1, wherein said White Alkanes comprise:
said n-paraffins in the range of 8% wt to 17% wt;
said cycloparaffins in the range of 0% wt to 6% wt; and
said carbon chains in the range of C14 to C22.

9. The WA-HRA immersion cooling fluid of claim 3, wherein said White Alkanes comprise:
said n-paraffins in the range of 8% wt to 17% wt;
said cycloparaffins in the range of 0% wt to 6% wt; and
said carbon chains in the range of C14 to C22.

10. The WA-HRA immersion cooling fluid of claim 1, wherein said highly refined alkanes comprise base stocks, wherein said base stocks are selected from one or more of: Group III base oil, Group III+base oil, gas to liquid hydrocarbons, Group IV base oil, natural esters or synthetic esters.

11. The WA-HRA immersion cooling fluid of claim 10, wherein said highly refined alkanes have a kinematic viscosity at 40° C. in a range of 3 cSt to 12 cSt.

12. The WA-HRA immersion cooling fluid of claim 1, wherein said WA-HRA immersion cooling fluid further comprises an additive, wherein said additive is selected from one or more of: an antioxidant, a wetting agent, a pour point depressant, a fluid flow improver, and/or corrosion inhibitors.

13. The WA-HRA immersion cooling fluid of claim 3, wherein said WA-HRA immersion cooling fluid further comprises an additive, wherein said additive is selected from one or more of: an antioxidant, a wetting agent, a pour point depressant, a fluid flow improver, and/or corrosion inhibitors.

14. The WA-HRA immersion cooling fluid of claim 4, wherein said WA-HRA immersion cooling fluid further comprises an additive, wherein said additive is selected from one or more of: an antioxidant, a wetting agent, a pour point depressant, a fluid flow improver, and/or corrosion inhibitors.

15. The WA-HRA immersion cooling fluid of claim 10, wherein said WA-HRA immersion cooling fluid further comprises an additive, wherein said additive is selected from one or more of: an antioxidant, a wetting agent, a pour point depressant, a fluid flow improver, and/or corrosion inhibitors.

16. The WA-HRA immersion cooling fluid of claim 1, wherein said WA-HRA immersion cooling fluid further comprises cycloparaffins in the range of 5% wt to 40% wt.

17. The WA-HRA immersion cooling fluid of claim 3, wherein said WA-HRA immersion cooling fluid further comprises cycloparaffins in the range of 5% wt to 40% wt.

18. The WA-HRA immersion cooling fluid of claim 4, wherein said WA-HRA immersion cooling fluid further comprises cycloparaffins in the range of 5% wt to 40% wt.

19. The WA-HRA immersion cooling fluid of claim 10, wherein said WA-HRA immersion cooling fluid further comprises cycloparaffins in the range of 5% wt to 40% wt.

20. The WA-HRA immersion cooling fluid of claim 1, wherein said WA-HRA immersion cooling fluid comprises White Alkanes in the range of 30% wt to 50% wt.

21. The WA-HRA immersion cooling fluid of claim 20, wherein said White Alkanes comprise:
said n-paraffins in the range of 8% wt to 17% wt;
said cycloparaffins in the range of 0% wt to 6% wt; and
said carbon chains in the range of C12 to C24.

22. The WA-HRA immersion cooling fluid of claim 10, wherein said Group III base oil comprises cycloparaffins in a range of 25% wt to 55% wt; wherein said Group III+base oil comprises cycloparaffins in a range of 4% wt to 25% wt.

23. The WA-HRA immersion cooling fluid of claim 22, wherein said WA-HRA immersion cooling fluid comprises White Alkanes in the range of 10% wt to 60% wt.

24. The WA-HRA immersion cooling fluid of claim 1, wherein said White Alkane has a pour point D97 value in the range of −24° C. to −3° C., and wherein said White Alkane has a kinematic viscosity at 40 C of 3 cSt to 5.5cSt.

25. The WA-HRA immersion cooling fluid of claim 1, wherein said White Alkane is manufactured from renewable diesel.

26. The WA-HRA immersion cooling fluid of claim 1, further comprising cycloparaffins in the range of 8% wt to 32% wt.

27. The WA-HRA immersion cooling fluid of claim 1, further comprising n-paraffins in the range of 4.5% wt to 17% wt.

28. The WA-HRA immersion cooling fluid of claim 1, further comprising n-paraffins in the range of 7% wt to 14% wt.

29. The WA-HRA immersion cooling fluid of claim 1, wherein said WA-HRA immersion cooling fluid has a kinematic viscosity at 40 C of 3.3 cSt to 8.5 cSt.

30. The WA-HRA immersion cooling fluid of claim 14, wherein said antioxidant is Benzenepropanoic acid, 3,5-bis(1,1-dimethylethyl)-4-hydroxy-, C7-9 branched alkyl esters.

31. The WA-HRA immersion cooling fluid of claim 14, further comprising polyalphaolefins (PAO) in a range of 0% wt to 35% wt.

32. The WA-HRA immersion cooling fluid of claim 10, further comprising said Group III base oil in a range of 0% wt to 30% wt, and wherein said Group III base oil has a kinematic viscosity at 40° C. of 18 cSt to 23 cSt.

33. The WA-HRA immersion cooling fluid of claim 10, further comprising said Group III+ base oil in a range of 0% wt to 30% wt, and wherein said Group III+ base oil has a kinematic viscosity at 40° C. of 18 cSt to 23 cSt.

34. A WA-HRA immersion cooling fluid comprising:
White Alkanes, wherein said White Alkanes comprise 10% wt to 60% wt of said WA-HRA immersion cooling fluid;
highly refined alkanes, wherein said highly refined alkanes comprise 40% wt to 90% wt of said WA-HRA immersion cooling fluid;
wherein said highly refined alkanes comprise base stocks, wherein said base stocks are selected from one or more of: Group III base oil, Group III+base oil, gas to liquid hydrocarbons, Group IV base oil, natural esters or synthetic esters; and
wherein said WA-HRA immersion cooling fluid further comprises n-paraffins and isoparaffins in the range of 60% wt to 95% wt, and further comprises cycloparaffins in the range of 5% wt to 40% wt.

35. The WA-HRA immersion cooling fluid of claim 33, wherein said WA-HRA immersion cooling fluid further comprises an additive, wherein said additive is selected from one or more of: an antioxidant, a wetting agent, a pour point depressant, a fluid flow improver, and/or corrosion inhibitors.

36. The WA-HRA immersion cooling fluid of claim 34, wherein said oxidant may be chosen from one or more of: Benzenepropanoic acid, 3,5-bis(1,1-dimethylethyl)-4-hydroxy-, C7-9 branched alkyl esters, or Butylated hydroxytoluene.
